(19) United States
(12) Patent Application Publication
(10) Pub. No.: US 2025/0267375 A1
(43) Pub. Date: Aug. 21, 2025

(54) IMAGING DEVICE AND OPERATING METHOD THEREOF

(71) Applicants: Samsung Electronics Co., Ltd., Suwon-si (KR); Carnegie Mellon University, Pittsburgh, PA (US)

(72) Inventors: Eunhee KANG, Suwon-si (KR); Anqi YANG, Pittsburgh, PA (US); Aswin SANKARANARAYANAN, Pittsburgh, PA (US); Hyong Euk LEE, Suwon-si (KR)

(73) Assignees: Samsung Electronics Co., Ltd., Suwon-si (KR); Carnegie Mellon University, Pittsburgh, PA (US)

(21) Appl. No.: 19/009,345

(22) Filed: Jan. 3, 2025

Related U.S. Application Data
(60) Provisional application No. 63/553,709, filed on Feb. 15, 2024.

(30) Foreign Application Priority Data
May 29, 2024 (KR) 10-2024-0070273

(51) Int. Cl. H04N 25/46; H04N 25/60

(52) U.S. Cl. CPC H04N 25/46; H04N 25/60

(57) ABSTRACT

A processor-implemented method includes dividing an input image captured by an image sensor into a plurality of regions, determining either one or both of a binning size and a gain value of the image sensor corresponding to each of the divided regions, based on a light level of the input image, performing binning by applying the either one or both of the binning size and the gain value, for each of the divided regions, and outputting a resulting image generated by performing image signal processing (ISP) on a result of the performing of the binning.

### CROSS-REFERENCE TO RELATED APPLICATIONS

This application claims the benefit under 35 U.S.C. § 119(e) of U.S. Provisional Application No. 63/553,709 filed on Feb. 15, 2024, in the U.S. Patent and Trademark Office, and claims the benefit under 35 USC § 119(a) of Korean Patent Application No. 10-2024-0070273 filed on May 29, 2024, in the Korean Intellectual Property Office, the entire disclosures of which are incorporated herein by reference for all purposes.

### BACKGROUND

### 1. Field

The following description relates to an imaging device and an operating method thereof.

### 2. Description of Related Art

Complementary metal-oxide-semiconductor (CMOS) manufacturing may enable the use of sub-micron pixels for smartphone cameras. While smaller pixels, such as sub-micron pixels, may provide higher resolution, there may also be performance degradation, such as an increasing noise and decreasing dynamic range of a sensor. For example, such sensor performance degradation due to photon noise, read noise, and dynamic range may be closely related to the small size of pixels.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes dividing an input image captured by an image sensor into a plurality of regions, determining either one or both of a binning size and a gain value of the image sensor corresponding to each of the divided regions, based on a light level of the input image, performing binning by applying the either one or both of the binning size and the gain value, for each of the divided regions, and outputting a resulting image generated by performing image signal processing (ISP) on a result of the performing of the binning.

The dividing into the plurality of regions may include either one or both of dividing the input image into the plurality of regions corresponding to a plurality of pixels, and dividing the input image into the plurality of regions corresponding to a plurality of regions of interest (ROIs).

The determining of the either one or both of the binning size and the gain value may include determining a corresponding binning size for each of the divided regions based on the light level of the input image, and determining a corresponding gain value for each of the divided regions based on the binning size.

The determining of the binning size may include determining the binning size based on a resolution corresponding to the light level.

The determining of the binning size may include determining a size of effective pixels among the plurality of pixels based on a light level-based pixel size-specific modulation transfer function (MTF), which is an MTF for each size of the plurality of pixels according to the light level, and on noise corresponding to the image sensor, and determining the binning size based on the size of the effective pixels.

The determining of the size of the effective pixels may include determining the size of the effective pixels by a first intersecting point between the light level-based pixel size-specific MTF and the noise.

The determining of the gain value may include determining the gain value for each of the plurality of pixels using a pixel intensity of a neighboring pixel adjacent to a target pixel among the plurality of pixels.

The determining of the gain value for each of the plurality of pixels may include determining a first maximum (max) light level for each of the plurality of pixels, and applying the first max light level to a saturation voltage value of the image sensor to determine the gain value for each of the plurality of pixels.

The determining of the binning size may include determining the binning size based on a resolution corresponding to a light level of each of the plurality of ROIs.

The determining of the gain value may include determining the gain value for each of the plurality of ROIs.

The determining of the gain value for each of the plurality of ROIs may include determining a second max light level for each of the plurality of ROIs, and applying the second max light level to a saturation voltage value of the image sensor to determine the gain value for each of the plurality of ROIs.

The performing of the binning may include performing the binning iteratively on each of the divided regions to allow the binning to be performed on an entirety of the input image.

The performing of the binning may include performing the binning by one or more binning modes among additive binning, average binning, and ISP post-processing binning.

The determining of the either one or both of the binning size and the gain value may include determining the gain value for each of the plurality of pixels, using a pixel intensity of a neighboring pixel.

The method may include determining whether to perform either one or both of a determination of the binning size and a determination of the gain value, for each of the divided regions, wherein, in response to the determination of the gain value being determined to be performed, the determining of the gain value may include determining a corresponding gain value for each of the divided regions, and capturing an image in which the gain value is applied to each of the divided regions, respectively.

In response to the determination of the binning size being determined to be performed, the performing of the binning further may include determining the binning size, and performing the binning on each of the divided regions based on the determined binning size.

The determining of the binning size and the determining of the gain value may be performed in parallel.

In one or more general aspects, a processor-implemented method includes dividing an input image captured by an image sensor into a plurality of regions, determining a corresponding binning size for each of the divided regions based on a light level of the input image, determining a corresponding gain value for each of the divided regions based on the binning size, performing binning on an image captured by applying the gain value to each of the divided regions, respectively, and outputting a resulting image generated by performing image signal processing (ISP) on a result of the performing of the binning.

In one or more general aspects, a processor-implemented method includes dividing a low-resolution image captured by an image sensor into a plurality of regions, determining a corresponding binning size for each of the divided regions based on a light level, determining a corresponding gain value for each of the divided regions based on the binning size, capturing, by the image sensor, a high-resolution image corresponding to the low-resolution image, applying the gain value to the high-resolution image, performing binning on the high-resolution image to which the gain value is applied, based on the binning size, and outputting a resulting image generated by performing image signal processing (ISP) on a result of the performing of the binning.

In one or more general aspects, an imaging device includes one or more processors configured to divide an input image captured by an image sensor into a plurality of regions, determine a corresponding binning size for each of the divided regions based on a light level of the input image, determine a corresponding gain value for each of the divided regions based on the binning size, perform binning on an image captured by applying the gain value to each of the divided regions, respectively, and perform image signal processing (ISP) on a result of performing the binning, and a communication interface configured to output a resulting image generated by the performing of the ISP.

Other features and aspects will be apparent from the following detailed description, the drawings, and the claims.

### BRIEF DESCRIPTION OF THE DRAWINGS

FIG. 1A illustrates noise generated in image sensors included in an imaging device according to one or more example embodiments.

FIG. 1B illustrates a relationship between a light level and a signal-to-noise ratio (SNR) in an imaging device including an image sensor according to one or more example embodiments.

FIG. 1C illustrates a spatially-varying gain and spatially-varying binning according to one or more example embodiments.

FIG. 2 illustrates a method of operating an imaging device according to one or more example embodiments.

FIG. 3 illustrates a method of operating an imaging device according to one or more example embodiments.

FIGS. 4A through 4C illustrate a method of determining a binning size according to one or more example embodiments.

FIGS. 5A and 5B illustrate a method of determining a spatially-varying gain value according to one or more example embodiments.

FIG. 6 illustrates a method of operating an imaging device according to one or more example embodiments.

FIGS. 7A and 7B illustrate a result of determining a spatially-varying gain value for each divided region using a pixel intensity of a neighboring pixel in an imaging device according to one or more example embodiments.

FIG. 8 illustrates a method of operating an imaging device according to one or more example embodiments.

FIG. 9 illustrates a method of operating an imaging device according to one or more example embodiments.

FIG. 10 illustrates a method of operating an imaging device according to one or more example embodiments.

FIG. 11 illustrates an imaging device according to one or more example embodiments.

FIG. 12 illustrates an example electronic device in which an imaging device is implemented according to one or more example embodiments.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the state.

Unless otherwise defined, all terms used herein including technical or scientific terms have the same meanings as those generally understood consistent with and after an understanding of the present disclosure. Terms, such as those defined in commonly used dictionaries, should be construed to have meanings matching with contextual meanings in the relevant art and the present disclosure, and are not to be construed as an ideal or excessively formal meaning unless otherwise defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

The example embodiments described below may be applied to, for example, neural networks, processors, smartphones, mobile devices, or the like that are intended to perform photorealistic rendering.

Hereinafter, examples will be described in detail with reference to the accompanying drawings. When describing the examples with reference to the accompanying drawings, like reference numerals refer to like components and a repeated description related thereto is omitted.

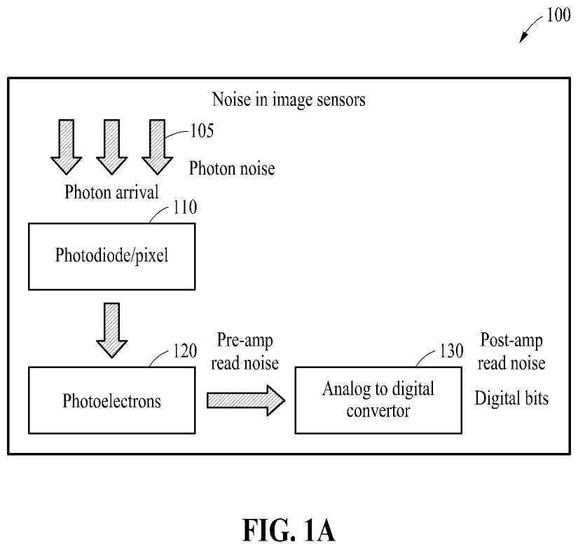

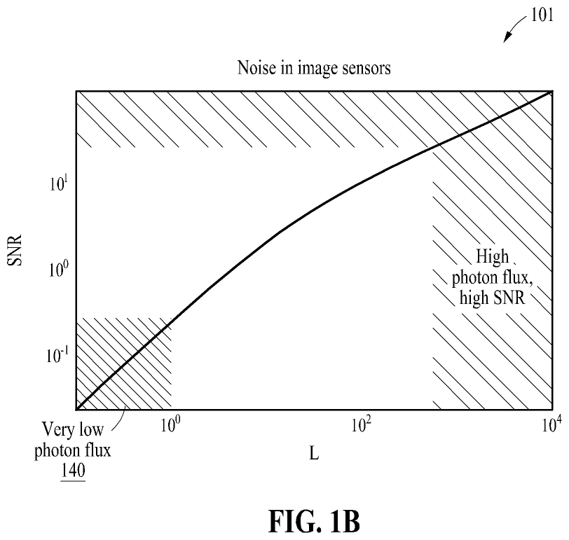

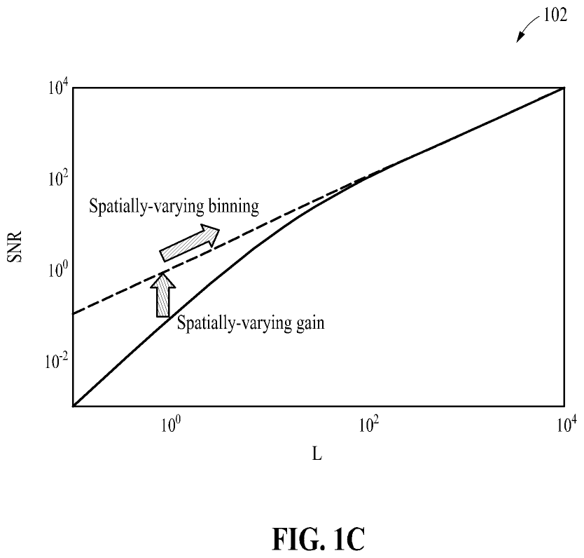

FIG. 1A illustrates noise generated in image sensors included in an imaging device according to one or more example embodiments. Referring to FIG. 1A, diagram illustrates noise generated in a process by which an image sensor 100 converts photons 105 incident on the image sensor 100 into digital values.

The noise in the image sensor 100 may be broadly classified into three types: photon noise I, read noise (nₚᵣₑ, nₚₒₛₜ), and dark current n_{D}. The photon noise I may follow a Poisson distribution “Poisson(I*)” with a mean and variance of the photons 105 expected to arrive at a photodiode 110 within an exposure time I*. The photon noise I may correspond to the number of photons 105 measured by the image sensor 100.

The dark current n_{D} may scale up linearly according to the exposure time and the temperature. In one or more embodiments, for example, an input image captured by the image sensor 100 may correspond to, but is not necessarily limited to, an image with an exposure time of up to a few hundred milliseconds, operating at a normal temperature and having a negligible dark current.

The read noise may include pre-amplifier read noise nₚᵣₑ corresponding to a signal (e.g., photoelectrons 120) input to an analog-to-digital (A/D) converter 130 including an amplifier, and post-amplifier read noise nₚₒₛₜ corresponding to a signal that has passed through the A/D converter 130. The pre-amplifier read noise nₚᵣₑ and the post-amplifier read noise nₚₒₛₜ may both be signal-independent and follow a Gaussian distribution with the mean being zero (0) and the variance being σₚᵣₑ and σₚₒₛₜ. The variance σₚᵣₑ may be a variance corresponding to the pre-amplifier read noise nₚᵣₑ, and the variance σₚₒₛₜ may be a variance corresponding to the post-amplifier read noise nₚₒₛₜ.

The post-amplifier read noise nₚₒₛₜ may be more significant (e.g., greater) than the pre-amplifier read noise nₚᵣₑ because σₚₒₛₜ is greater than σₚᵣₑ by a factor of one to two times, for most image sensors, in an example.

For example, an intensity i of a digital image detected by the image sensor 100 may be expressed as Equation 1 below, for example.

$$i = Φ \{ g \cdot ( ql + {n}_{D} + {n}_{pre} ) + {n}_{post} \} + {i}_{0} , l \sim Poisson ( {l}^{*} ) . \qquad Equation 1$$

In Equation 1, Φ may denote an analog-to-digital conversion (ADC). For most image sensors, a bit depth may be greater than a dynamic range, and it may thus be assumed that ADC noise is small. In Equation 1, q may denote a quantum efficiency, which may be fixed to each photodiode 110. In one or more embodiments, the quantum efficiency q may be negligible as the effect of the quantum efficiency q is absorbed by the photon noise I.

In Equation 1, g may denote a gain (e.g., analog gain). The gain g may have various values (e.g., 1 to several hundred). In Equation 1, i₀ may denote a black level, e.g., an initial light level value in the absence of light. For example, although, for an image sensor, the initial light level value should be zero (0) in the absence of light, an electronic device may have a default voltage that is applied initially. The black level may also refer to this initially applied voltage in the electronic device. In image signal processing (ISP) of a sensor or camera, the black level may be corrected through a black level correction module.

Under the preceding assumption, a noise model may be simplified to estimate the number \hat{l} of photons 105 in a noisy digital image, as expressed in Equation 2 below, for example.

$$\hat{l} = {Φ}^{- 1} ( i - {i}_{0} ) / g = l + {n}_{pre} + {n}_{post} / g . \qquad Equation 2$$

In Equation 2, an expected value of the number \hat{l} of photons 105 may be l*, and a total variance may be l*+σₚᵣₑ²+σₚₒₛₜ²/g². Further, a signal-to-noise ratio (SNR) may be expressed as SNR(l)=l*/\sqrt{l*+σₚᵣₑ²+σₚₒₛₜ²/g²}.
In one or more embodiments, the noise model expressed as Equation 2 may be used to determine the following in relation to a constant gain and constant binning (e.g., pixel binning).

With respect to the constant gain, a large value of gain may significantly reduce σₚₒₛₜ²/g² which is a post-amplifier read noise term. Because σₚᵣₑ is much smaller than σₚₒₛₜ², both read noise may be negligible. This may be of great help in low-light imaging, where a standard deviation of read noise is of similar magnitude to the expected value I*. The large value of gain may overcome the effect of read noise, increase an SNR to approximately \sqrt{l*}, and limit photon noise. However, for a scene that spans a wide dynamic range, increasing a gain in a dark region may saturate a bright region, which may limit the choice of the large value of gain.

In addition, with respect to the constant binning, binning neighboring pixels together may increase the SNR. Averaging N pixels, considering may result in a standard deviation between the expected value l* and \sqrt{l*/N}. Therefore, the overall SNR may increase from \sqrt{l*} to \sqrt{Nl*}, where N may correspond to the binning size.

However, binning may have the side effects of pixelation and loss of resolution. Therefore, the binning size N that generates the highest SNR for a low-light region may be achieved at the expense of fine details in a bright region.

In the example embodiments described below, the imaging device of one or more embodiments may improve noise performance in dark regions while maintaining the image quality in bright regions, using a spatially-varying gain and spatially-varying binning, which are described with reference to FIG. 1C. Hereafter, the “spatially-varying gain” may also be simply referred to as a “(spatially) variable gain,” and the “spatially-varying binning” may also be simply referred to as a “(spatially) variable binning.”

As will be described in examples in more detail below, the imaging device of one or more embodiments may set different gains for different signal levels in a single image to effectively reduce read noise for a dark scene without saturating a bright region, thereby improving noise performance in dark regions while maintaining the image quality in bright regions.

Further, the imaging device of one or more embodiments may perform spatially-varying binning in which the binning size of pixels is determined by the light level of a scene.

The term “pixel” used herein may be a basic unit of information that forms an image, and may refer to optical information obtained as a sensing element senses light reflected from a physical position on a subject corresponding to a pixel position. The pixel position, which may refer to a position of a pixel in an image, may be in a pixel coordinate system, while its physical position may be in a world coordinate system.

For reference, a pixel that forms a color image may have a pixel value for one pixel position. The pixel value may have a plurality of color values (e.g., a red value, a green value, and a blue value in a red, green, and blue (RGB) color system). In a field of displays, a unit pixel that forms a display may include subpixels (e.g., a red subpixel, a green subpixel, and a blue subpixel in the RGB color system) for a plurality of colors to represent color values at one pixel position. In contrast, in a field of image sensors, it is common that a pixel refers to a sensing element (e.g., a photodiode with a color filter disposed at a front end) that senses a single color value, rather than being divided into subpixels for each color. Also, in the field of image sensors, a pixel is sometimes used interchangeably to refer to a sensing element and a value sensed by the sensing element.

For example, a pixel value of each pixel may be determined based on sensing by a single sensing element or sensing by a plurality of sensing elements grouped by binning. Binning may be used to improve photosensitivity of the imaging device and/or image sensor 100 and improve image quality in a low-light environment. There is a limit to the amount of light to be sensed by a single sensing element, and sensitivity may be improved by representing a pixel using values sensed by a plurality of sensing elements.

The term “light level” used herein may refer to illuminance or a lighting level. Spatially-varying binning of one or more embodiments may effectively reduce the noise level of an image while ensuring high resolution for bright scenes. By combining a spatially-varying gain and spatially-varying binning, the imaging device of one or more embodiments may reduce the read noise and photon noise while extending the dynamic range of the image sensor 100.

As will be described in examples in more detail below, the quality of an image captured and restored by the image sensor 100 may be determined by the number of sensing elements included in a sensing array and the amount of light incident on the sensing elements. For example, the resolution of the image may be determined by the number of the sensing elements included in the sensing array of the image sensor 100 and/or the binning size, and the sensitivity of the image may be determined by the amount of light incident on the sensing elements. Further, the amount of light incident on the sensing elements may be determined based on the size of the sensing elements and/or the binning size. As the size of the sensing elements and/or the binning size increases, the amount of light incident on the sensing elements may increase, and the dynamic range of the sensing array may also increase. Therefore, as the number of sensing elements included in the sensing array increases, the image sensor 100 may capture an image of a higher resolution. As the size of the sensing elements and/or the binning size increases, the image sensor 100 may operate more effectively in high-sensitivity imaging in a low-light environment.

FIG. 1B is a diagram illustrating a relationship between a light level and an SNR in an imaging device including an image sensor according to one or more example embodiments. Referring to FIG. 1B, diagram 101 illustrates a relationship between a light level (indicated as “L”) and an SNR in the imaging device including an image sensor.

For example, in a case where total noise is limited to photon noise, the SNR may decrease according to the number of photons. In this example, a region of small pixels may receive fewer photons within a fixed exposure time, and thus the SNR may be degraded further. A noise level of read noise may be determined by the quality of a read circuit, and may thus remain the same throughout pixel sizes. A pixel size described herein may also be referred to as a “pixel pitch.”

However, an SNR of small pixels may still decrease as a signal level decreases. In addition, since the dynamic range is typically determined by a ratio between a maximum (or “max” herein) well capacity and a read noise floor, and the small pixels often have a smaller well capacity, the dynamic range by the small pixels may be smaller compared to the dynamic range by large pixels. The “well capacity” described herein may refer to a total amount of charges a pixel is able to hold before it becomes saturated. The “read noise” described herein may refer to noise generated as a photon is converted into an electrical signal, and the “read noise floor” described herein may refer to both pre-amplifier read noise nₚᵣₑ and post-amplifier read noise nₚₒₛₜ, as shown in FIG. 1A.

Based on the foregoing, Equation 1 may be expressed in the form of Equation 3 below, for example.

$$i = G ( Poisson ( L ) + {n}_{pre} ) + {n}_{post} \\ \hat{L} = \frac{i}{G} \\ E ( \hat{L} ) = L \qquad Equation 3$$

In addition, a standard deviation (var) and an SNR, as a function of a light level (L), may be expressed as Equation 4 below, for example.

$$var ( \hat{L} ) = L + {σ}_{pre}^{2} + \frac{{σ}_{post}^{2}}{{G}^{2}} \\ SNR ( L ) = \frac{L}{\sqrt{L + {σ}_{pre}^{2} + \frac{{σ}_{post}^{2}}{{G}^{2}}}} \qquad Equation 4$$

Therefore, in one or more embodiments, the effects of read noise and photon noise may be effectively suppressed, and the dynamic range may be extended, by considering the following two points.

First, by increasing an analog gain, post-amplifier read noise may be negligible. This strategy may dramatically improve noise performance in dark regions, where read noise is dominant. However, maximizing a gain in a dark region may eventually saturate a bright region of the same scene, limiting the use of an extremely large gain.

Second, a simple way to suppress the effect of photon noise may be to group neighboring pixels together, i.e., binning neighboring pixels together. Binning neighboring pixels together may effectively increase the SNR. However, binning may generate larger pixels, and applying the same binning size to the entire image sensor may unnecessarily sacrifice high-frequency details of bright regions.

Therefore, in one or more embodiments, spatially-varying gain and binning may be used to suppress the effects of noise and extend a dynamic range of the image sensor, as shown in FIG. 1C.

The imaging device of one or more embodiments may use a spatially-varying gain and spatially-varying binning to improve the image quality of a low photon flux region 140 that has a low light level and a low SNR in an input image, as shown in FIG. 1B.

FIG. 1C illustrates a spatially-varying gain and spatially-varying binning according to one or more example embodiments. Referring to FIG. 1C, diagram 102 illustrates how a spatially-varying gain and spatially-varying binning in the graph of FIG. 1B are used to adjust noise performance and a dynamic range of an image sensor, according to one or more example embodiments.

According to one or more embodiments, the imaging device of one or more embodiments may apply a spatially-varying gain and spatially-varying binning to improve noise performance of an image sensor and a dynamic range of the image sensor in a single shot, as shown in FIG. 1C.

For example, in the case of a spatially-varying adaptive gain, the imaging device may determine a maximum (max) gain of pixels in a patch or each individual pixel to obtain a saturation with a small probability. A large analog gain may be applied to a pixel with few photons, and a small gain may be applied to a pixel at which photons arrive. The imaging device of one or more embodiments may extend the dynamic range of the image sensor by reducing a noise floor to pre-amplifier read noise. The pre-amplifier read noise may be smaller than post-amplifier read noise by a factor of one to two times.

For example, the imaging device may extend the dynamic range of the image sensor by using a low-resolution image (e.g., snapshot) to inform gain selection in subsequent captures or by using readout values from previous pixels to predict an optimal gain for a subsequent pixel.

Also, in the case of spatially-varying adaptive binning, the imaging device may consider an illuminance (or light level) of a scene to determine an optimal binning size corresponding to a threshold value of a specific SNR, and map the light level of the scene to the determined optimal binning size. This may allow larger binning to provide better resolution in dark regions. Since binning is equivalent to increasing a pixel size, the imaging device of one or more embodiments may significantly reduce noise by binning to increase resolution. Binning may include, for example, three binning modes: analog additive binning, analog average binning, and digital binning.

The imaging device of one or more embodiments may combine the spatially-varying gain and binning to reduce both read noise and photon noise for high dynamic range imaging, vignetting, and spatially-varying lens distortion. Here, the term “vignetting” described herein may refer to darkening or blackening corners or outer edges of a captured image due to a light amount decrease around a lens.

The imaging device of one or more embodiments may use the spatially-varying gain and spatially-varying binning to improve the image quality of the low photon flux region 140 that have a low light level and a low SNR in an input image, as shown in FIG. 1B.

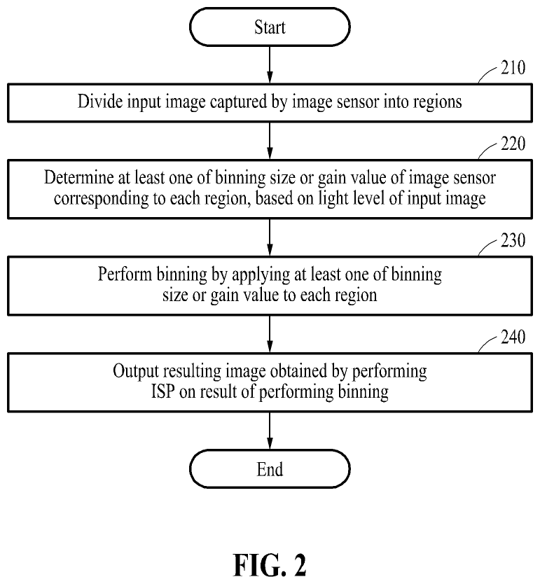

FIG. 2 illustrates a method of operating an imaging device according to one or more example embodiments. In embodiments described with reference to FIG. 2 and the following drawings, steps or operations may be performed in sequential order but may not necessarily be performed in sequential order. For example, the order of the steps or operations may be changed, and at least two of the steps or operations may be performed in parallel, or one step or operation may be divided to be performed accordingly.

Referring to FIG. 2, according to one or more embodiments, the imaging device may improve the image quality of an image by performing operations 210 to 240 described below.

In operation 210, the imaging device may divide an input image captured by an image sensor into a plurality of regions. The imaging device may divide the input image into a plurality of regions corresponding to a plurality of pixels. Alternatively or additionally, the imaging device may divide the input image into a plurality of regions corresponding to a plurality of regions of interest (ROIs).

In operation 220, the imaging device may determine at least one of a binning size or a gain value of the image sensor corresponding to each of the regions divided in operation 210, based on a light level of the input image.

Based on the light level of the input image, the imaging device may determine a binning size corresponding to each of the divided regions. The imaging device may determine the binning size based on a resolution corresponding to the light level. The imaging device may determine the size of effective pixels among the plurality of pixels based on a light level-based pixel size-specific modulation transfer function (MTF) for each of the plurality of pixels and on noise corresponding to the image sensor. For example, the imaging device may determine the size of the effective pixels based on a first intersecting point between the light level-based pixel size-specific MTF of the plurality of pixels and the noise. Based on the size of the effective pixels, the imaging device may determine the binning size. The MTF described herein may be an indicator that evaluates the performance of a camera or lens, which may represent, as a spatial frequency characteristic, how faithfully the contrast of an object is reproduced. An ideal lens MTF value may be 1.

The imaging device may determine a gain value corresponding to each of the divided regions based on the binning size. The imaging device may determine the gain value for each of the plurality of pixels using a pixel intensity of a neighboring pixel that is adjacent to a target pixel among the plurality of pixels. For example, the imaging device may determine the gain value for each of the plurality of pixels by determining a first max light level for each of the plurality of pixels and applying the first max light level to a saturation voltage value of the image sensor. For example, the imaging device may apply a large analog gain to a pixel at which fewer photons arrive and a small analog gain to a pixel at which more photons arrive. The imaging device of one or more embodiments may adjust the gain of the image sensor based on the light level and perform binning to improve the image quality of a dark region or a low-light image.

Alternatively or additionally, the imaging device may determine the binning size based on the resolution corresponding to the light level for each of a plurality of ROIs. In this example, the imaging device may determine a gain value for each of the plurality of ROIs. The imaging device may determine a second max light level for each of the plurality of ROIs. The imaging device may apply the second max light level to the saturation voltage value of the image sensor to determine the gain value for each of the plurality of ROIs.

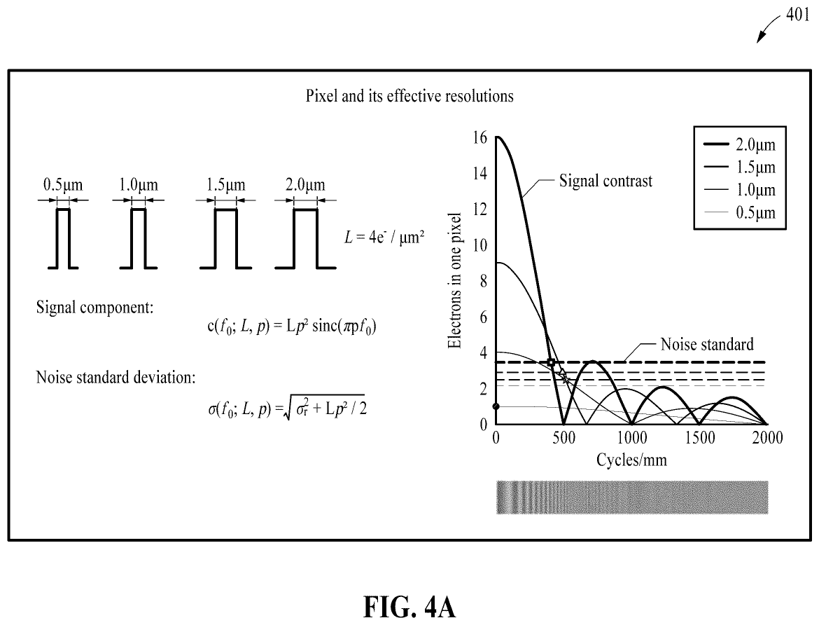

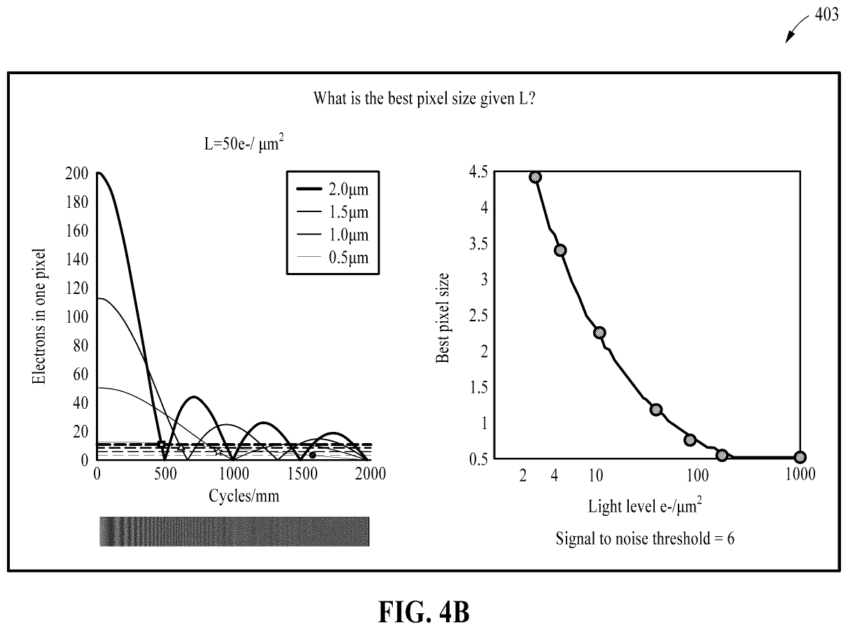

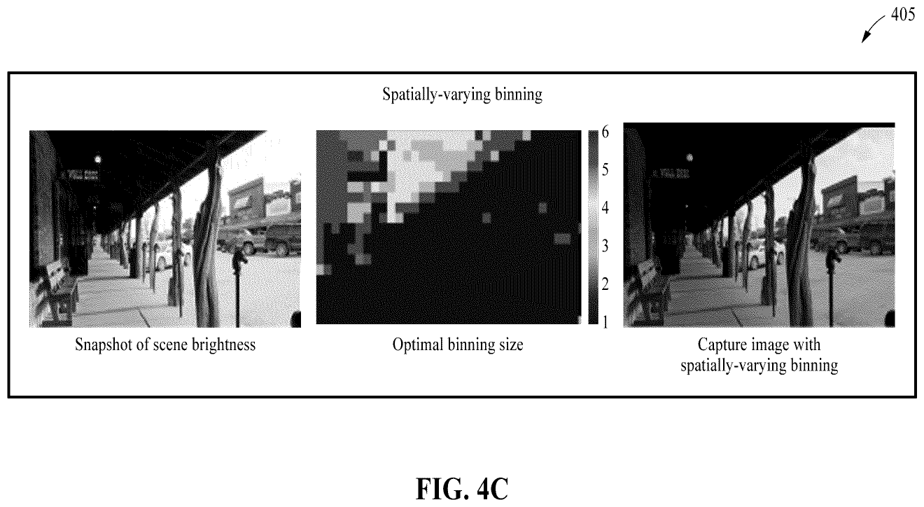

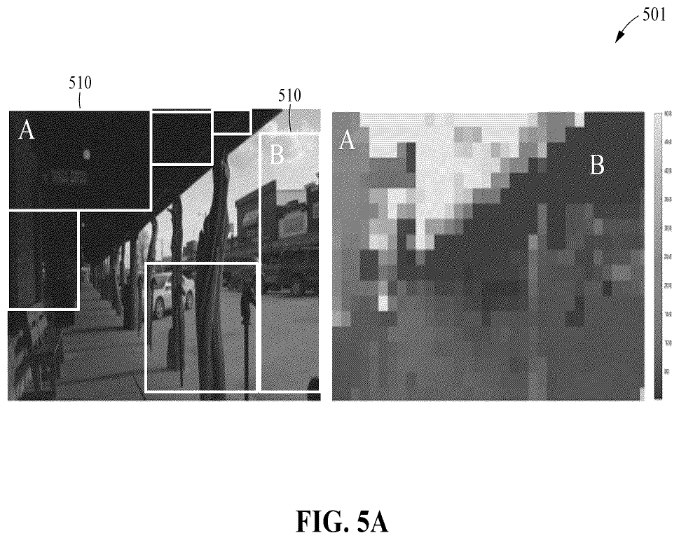

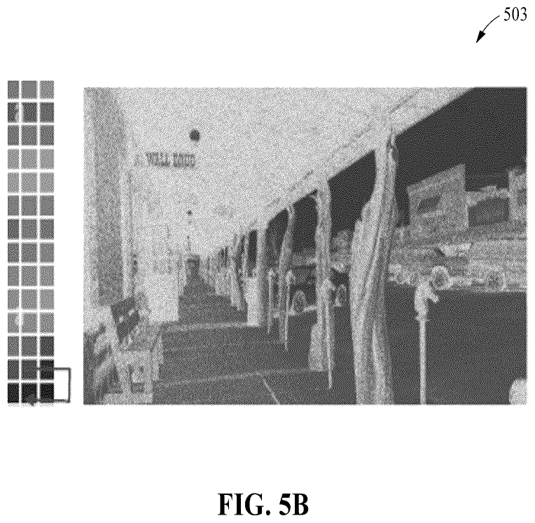

An example of the method of determining a corresponding binning size for each of the divided regions by the imaging device will be described in more detail below with reference to FIGS. 4A and 4B. Also, an example of the method of determining a corresponding gain value for each of the divided regions by the imaging device will be described in more detail below with reference to FIGS. 5A and 5B.

In operation 230, the imaging device may perform binning by applying at least one of the binning size or the gain value determined in operation 220 to each of the divided regions. The imaging device may perform the binning iteratively on each of the divided regions, such that the binning is performed on the entire input image. For example, the imaging device may perform the binning according to at least one of the following binning modes (or binning techniques): additive binning, average binning, and ISP post-processing binning. The additive binning and the average binning may correspond to analog binning, and the ISP post-processing binning may correspond to digital binning.

In operation 240, the imaging device may output a resulting image obtained by performing ISP on a result of performing the binning in operation 230.

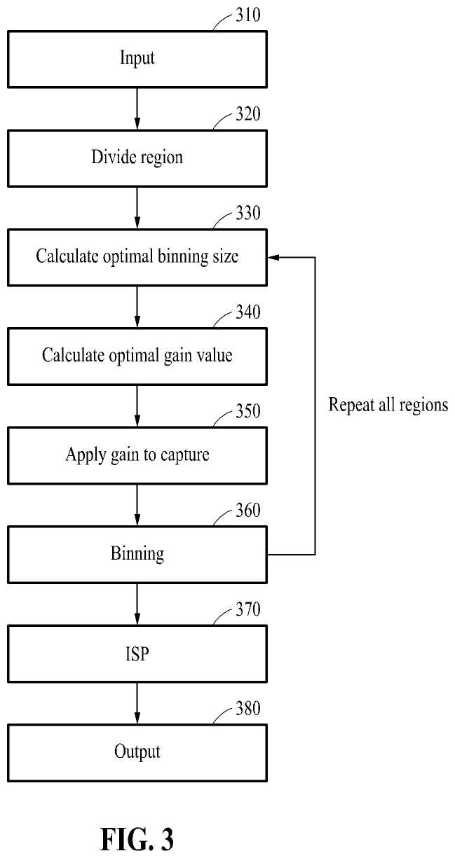

FIG. 3 illustrates a method of operating an imaging device according to one or more example embodiments. In embodiments described with reference to FIG. 3 and the following drawings, steps or operations may be performed in sequential order but may not necessarily be performed in sequential order. For example, the order of the steps or operations may be changed, and at least two of the steps or operations may be performed in parallel, or one step or operation may be divided to be performed accordingly. Referring to FIG. 3, according to one or more embodiments, the imaging device of one or more embodiments may improve the image quality of an image by performing operations 310 to 360 described below.

In operation 310, the imaging device may receive an input image captured by an image sensor. For example, in operation 310, the imaging device may include the image sensor and may capture the input image using the image sensor.

In operation 320, the imaging device may divide the input image received in operation 310 into a plurality of regions. After dividing the input image into the plurality of regions, the imaging device may obtain an optimal binning size and gain value for each of the divided regions.

In operation 330, the imaging device may determine a corresponding binning size for each of the regions divided in operation 320 based on a light level of the input image. An example of the method of determining the binning size by the imaging device will be described in more detail below with reference to FIGS. 4A through 4C.

In operation 340, the imaging device may determine a corresponding gain value for each of the regions divided in operation 320, based on the binning size determined in operation 330. In this example, increasing a gain value of the image sensor may improve an SNR but may result in a saturated region in the image. In one or more embodiments, applying a spatially-varying gain value for each of the divided regions may prevent the generation of a saturated region.

The imaging device may change a gain value for each region using the following two methods. The imaging device may divide the input image into a plurality of ROIs and determine a gain value corresponding to each of the ROIs. Alternatively or additionally, the imaging device may determine a gain value for each pixel using a pixel intensity of a neighboring pixel among a plurality of pixels in the input image. An example of the method of determining a gain value using a plurality of ROIs will be described in more detail below with reference to FIG. 5A, and an example of the method of determining a gain value using a pixel intensity of a neighboring pixel will be described in more detail below with reference to FIG. 5B.

In operation 350, the imaging device may apply the gain value determined in operation 340 for each of the divided regions.

In operation 360, the imaging device may perform binning on an image to which the gain value is applied in operation 350. The imaging device may apply the binning after capturing a result (e.g., an image) of applying the gain value to each of the divided regions. The imaging device may iteratively perform operations 330 to 360 until the binning is completed for all the divided regions.

In operation 370, the imaging device may perform ISP on a result of performing the binning in operation 360 to generate a resulting image. The imaging device may perform the ISP on the result of applying the binning to all the divided regions to obtain the resulting image.

In operation 380, the imaging device may output the resulting image generated in operation 370.

FIGS. 4A through 4C illustrate a method of determining a binning size according to one or more example embodiments.

When, even in a single image, different portions of the image may have different amounts of light, there may be a difference in image quality between the portions of the image. For example, adjusting a gain value to prevent a bright portion from being saturated may make a dark portion darker due to less gain. However, performing binning not according to a bright portion of an image may degrade the image quality due to more noise in a dark portion of the image.

Alternatively, performing binning according to a darker portion in an image may degrade the image quality due to a lower resolution in a bright portion of the image. As such, a trade-off relationship may be established between a resolution and noise of an image.

The imaging device of one or more embodiments may overcome the disadvantage of small pixels in obtaining good image quality by performing binning that groups small pixels into a large pixel. Since binning may be closely connected to a light level of a scene, the imaging device of one or more embodiments may find (e.g., determine) an optimal pixel size that maximizes an effective resolution by considering a predetermined SNR threshold being effective for a given light level of a scene corresponding to an input image. In this example, the smaller the pixel size, the higher the effective resolution, but the smaller the pixel size, the higher the noise level. Therefore, the imaging device of one or more embodiments may find the optimal pixel size that best compromises the resolution and the noise.

In one or more embodiments, the imaging device of one or more embodiments may find the optimal pixel size that best compromises the resolution and the noise by spatially-varying pixel binning that is adaptive to the brightness of a scene.

Binning may reduce the resolution but may increase a light level to improve the SNR. The imaging device of one or more embodiments may thus find a resolution suitable for the light level and determine a binning size that implements the suitable resolution through binning.

The imaging device may use binning modes, such as, for example, analog additive binning, analog average binning, and digital binning, to select an optimal binning size to achieve the highest resolution at a given brightness of a scene. Both the analog binning modes may be performed on analog signals. In the analog additive binning mode, the image sensor may read a photoelectron count and read it as an analog voltage, and then add analog voltages of N neighboring pixels together. In this example, the added signal may be amplified by a factor of g by an amplifier and finally read out as a digital value. The analog average binning mode may be the same as the analog additive binning mode, except that the combined voltage is an average of the voltages of the N neighboring pixels. In the digital binning mode, signals may be read as digital values and then binned.

The imaging device may use pixel binning to achieve the optimal pixel size.

Hereinafter, a method of reducing photon noise using spatially-varying binning (or “spatially variable binning”) by the imaging device will be described.

For example, the imaging device of one or more embodiments may analyze the optimal pixel size to determine the optimal pixel size that achieves the highest effective resolution at a given light level of a scene. The term “effective resolution” described herein may be defined as a frequency at which a ratio between a noise-free signal contrast and a measured noise standard deviation is greater than a predefined threshold SNRt. In a case of the highest effective resolution with an SNR being equal to the threshold SNRt, all frequencies smaller than the threshold SNRt may be effective resolutions.

For example, a scene with a sinusoidal function that varies in an x-direction frequency f₀ but is constant in a y-direction and has the highest photoelectron intensity I₀ per square micrometer within an exposure time may be considered.

A signal (or an expected value) I*(x,y,f₀;I₀,p) measured by a camera with an ideal lens and an image sensor with a pixel size of p μm may be modeled as a convolution between the signal and a box function induced by the pixel size, as expressed in Equation 5 below, for example.

$${l}^{*} ( x , y , {f}_{0} ; {l}_{0} , p ) = \{ {l}_{0} cos ( 2 π {f}_{0} x ) + {l}_{0} / 2 \} * b \{ \frac{x}{p} , \frac{y}{p} \} . \qquad Equation 5$$

The imaging device may model the expected noise-free signal measurement by integrating a blurring effect of the pixel size into the signal (expected value) I*(x,y,f₀;I₀,p). A noise-free signal contrast c(f₀;I₀,p) may be expressed in Equation 6 below, for example.

$$c ( {f}_{0} ; {l}_{0} , p ) = \vert max {l}^{*} - min {l}^{*} \vert = {l}_{0} {p}^{2} \frac{sin ( π {pf}_{0} )}{π {f}_{0}} . \qquad Equation 6$$

The imaging device may connect the expected signal to the noise model expressed in Equation 1 and obtain a measured noise value. In this example, a total noise variance σ(f₀;I₀,p) may be expressed in Equation 7 below, for example.

$$σ ( {f}_{0} ; {l}_{0} , p ) = \sqrt{{σ}_{pre}^{2} + {σ}_{post}^{2} / {g}^{2} + {l}_{0} {p}^{2} / 2} , \qquad Equation 7$$

In this example, read noise may be independent of the pixel size, and a shot noise variance I₀p²/2 may increase in proportion to a pixel region p². Shot noise, which is a type of white noise in which the energy of discontinuous photons is measured and acted as noise, may have the same magnitude at all frequencies.

Therefore, a cutoff frequency f_{cutoff}(I₀,p) with the threshold SNRt may be expressed in Equation 8 below, for example.

$${f}_{cutoff} ( {l}_{0} , p ) = arg {min}_{{f}_{0}} ‖ \frac{c ( {f}_{0} ; {l}_{0} , p )}{σ ( {f}_{0} ; {l}_{0} , p )} - {SNR}_{t} ‖ \qquad Equation 8$$

Referring to FIG. 4A, diagram 401 illustrates a set of curves of a pixel size-specific MTF and noise according to the size p and the given light level I₀.

Considering the threshold SNRt being 1 (i.e., SNRt=1), the two curves may intersect at the cutoff frequency f_{cutoff}(I₀,p). The cutoff frequency f_{cutoff}(I₀,p) may correspond to a frequency at which the image sensor with the pixel size p has an effective pixel size at the given light level I₀.

As shown in FIG. 4A, the imaging device may analyze various pixel sizes p* ranging from 0.5 μm to 2.0 μm at the same light level I₀ and find a pixel size that achieves the highest cutoff frequency, i.e., p*(l₀)=arg maxₚ f_{cutoff}(I₀,p).

For example, the imaging device may determine the size of effective pixels by a first intersecting point between the pixel size-specific MTF and the noise.

Referring to FIG. 4B, diagram 403 illustrates a pixel size p that achieves a max cutoff frequency under the condition with a given light level and a threshold SNRt of 6 (i.e., SNRt=6), for example.

Referring to FIG. 4C, diagram 405 illustrates a process of dividing an input image into a plurality of ROIs, finding an optimal pixel size based on a light level of a corresponding ROI, and determining and applying a binning degree.

The optimal pixel size may be a function of light level, and the optimal pixel size may decrease as a scene gets brighter, as shown in FIG. 4C. This may provide a view indicating smaller pixels are suitable for a bright scene and larger pixels are suitable for a dark scene. SNRt, an SNR threshold, may be a hyperparameter that is determined empirically by examining a measured image quality set.

According to one or more embodiments, a noise model (or imaging model) and a total noise variance according to binning modes may be summarized as shown in Table 1 below, for example.

TABLE 1

| Binning modes | Imaging model \hat{l} | Total noise variance |
|---|---|---|
| No binning | $l + {n}_{pre} + \frac{{n}_{post}}{g}$ | ${l}^{*} + {σ}_{pre}^{2} + \frac{{σ}_{post}^{2}}{{g}^{2}}$ |
| Analog additive binning | $\frac{1}{N} {\sum }_{i = 1}^{N} \{ {l}_{i} + {n}_{i , pre} \} + \frac{{n}_{post}}{N \hat{g}}$ | $\frac{{l}^{*}}{N} + \frac{{σ}_{pre}^{2}}{N} + \frac{{σ}_{post}^{2}}{{N}^{2} {\hat{g}}^{2}}$ |
| Analog average binning | $\frac{1}{N} {\sum }_{i = 1}^{N} \{ {l}_{i} + {n}_{i , pre} \} + \frac{{n}_{post}}{g}$ | $\frac{{l}^{*}}{N} + \frac{{σ}_{pre}^{2}}{N} + \frac{{σ}_{post}^{2}}{{g}^{2}}$ |
| Digital binning | $\frac{1}{N} {\sum }_{i = 1}^{N} \{ {l}_{i} + {n}_{i , pre} + \frac{{n}_{i , post}}{g} \}$ | $\frac{{l}^{*}}{N} + \frac{{σ}_{pre}^{2}}{N} + \frac{{σ}_{post}^{2}}{{Ng}^{2}}$ |

The three binning modes described above may all reduce photon noise by a factor of N.

To prevent saturation, analog additive binning may use a gain that is about N times smaller than that of digital binning. For example, using ĝ=g/N, a read noise variance of analog additive binning may be

$$\frac{{σ}_{post}^{2}}{{N}^{2} {\hat{g}}^{2}} = \frac{{σ}_{post}^{2}}{{g}^{2}} ,$$

which may be larger than that of digital binning.

FIGS. 5A and 5B illustrate a method of determining a spatially-varying gain value according to one or more example embodiments.

Referring to FIG. 5A, diagram 501 illustrates how the imaging device determines a spatially-varying gain value for a plurality of regions corresponding to a plurality of ROIs, according to one or more example embodiments.

According to one or more embodiments, the imaging device of one or more embodiments may use the spatially-varying gain to enable a large gain in a dark scene and prevent saturation in a bright scene. The imaging device of one or more embodiments may use the spatially-varying gain that is adaptive to the brightness of a scene to effectively reduce read noise in dark regions while preventing bright regions from being saturated. This may allow the imaging device of one or more embodiments to effectively extend a dynamic range of an image sensor and capture a high dynamic range by a single shot.

The imaging device may first divide an input image into a plurality of ROIs and then set a gain for each ROI based on a snapshot light level.

The imaging device may divide the input image into the plurality of ROIs such that each ROI has a smaller dynamic range, rather than using a constant gain over the entire input image. As shown in FIG. 5A, region A does not have bright pixels, and thus a large gain may be applied to pixels of region A. Also, region B is under direct sunlight, and thus a small gain may be applied to pixels of region B. In ROI-based implementations, additional snapshots of a scene may be used to determine a light level, ROIs, and a gain for each ROI.

For example, when an estimated scene light level (i.e., [symbol] (\hat{l})=l*) is given for the number \hat{l} of photons, the imaging device may find a max gain that allows an amplified signal gl to be saturated with a small probability.

In one or more embodiments, a heteroscedastic Gaussian noise model may be adopted, and the amplified signal may be approximated by a Gaussian distribution, i.e.,

$$g \cdot ( l + {n}_{pre} ) + {n}_{post} \sim ( g \hat{l} , {g}^{2} \hat{l} + {g}^{2} {σ}_{pre}^{2} + {σ}_{post}^{2} ) .$$

In this example, an expected amplified signal g\hat{l} may be close to a well capacity I_{wc} and is much larger than a read noise variance, and thus a total variance may be further simplified as g²\hat{l}.

To make the saturation probability smaller, the imaging device may set the well capacity to a η-variance greater than the expected amplified signal g\hat{l}, and obtain a gain g as expressed in Equation 9 below, for example.

$${l}_{wc} \approx g \hat{l} + η g \sqrt{\hat{l}} . \qquad Equation 9$$

In Equation 9, η denotes a hyperparameter, and when η=2, a pixel may be saturated with a probability of about 2.2%. l_{wc} may correspond to the well capacity.

The gain g of a corresponding region (e.g., an ROI or pixel) may be expressed in Equation 10 below, for example.

$$g = {v}_{max - saturate} / ( {l}_{max} + η \sqrt{{l}_{max}} ) \qquad Equation 10$$

To obtain a max gain value without saturating pixels, the imaging device may find a max light level lₘₐₓ of a corresponding region and then apply a value (lₘₐₓ+η\sqrt{lₘₐₓ}) that is based on the max light level to a saturation voltage value, i.e., vₘₐₓ₋ₛₐₜᵤᵣₐₜₑ, of the sensor to obtain the gain g.

The spatially-varying gain may improve an SNR by allowing the photon noise to act dominantly at all light levels.

Referring to FIG. 5B, diagram 503 illustrates a method of determining a spatially-varying gain value for a plurality of regions corresponding to a plurality of pixels, according to one or more example embodiments. Diagram 503 may correspond to a per-pixel gain map provided to read an image of a high dynamic range scene.

Unlike the ROI-based gain determination method described above with reference to FIG. 5A, the per-pixel gain determination method illustrated in FIG. 5B may use only a single shot and set a gain during reading.

Since an image is typically piecewise smooth, a readout value of one pixel may be used to estimate a gain of a subsequent pixel, under the assumption that a light level of a pixel is close to that of its neighboring pixel.

For example, the imaging device may estimate a light level lₖ from a readout value and a gain of a kth pixel and use the light level lₖ as a rough estimate \hat{l}ₖ₊₁≈lₖ of a light level of a subsequent pixel.

In connection with Equation 9, a gain gₖ₊₁ for a k+1th pixel may be determined, and the determined gain may be set in an ADC circuit for readout.

A spatially-varying gain may extend a dynamic range of the image sensor by a factor of one to two times by a single exposure. This is because the dynamic range of the image sensor is generally determined by a ratio of well-capacity l_{wc} and a read noise floor l_{wc}/\sqrt{σₚᵣₑ²+σₚₒₛₜ²/g²}.

A typical image sensor with a constant gain to capture a high dynamic range scene may be restricted to use a small gain g to prevent a bright object from being saturated, and a variation of post-amplifier read noise may be much larger than a variance of pre-amplifier read noise. Therefore, σₚₒₛₜ²/g²>>σₚᵣₑ² and the dynamic range of the image sensor may be approximately l_{wc}/σₚₒₛₜ.

In contrast, according to one or more embodiments, the spatially-varying gain may use a large gain g to capture a dark region to effectively reduce the post-amplifier read noise σₚₒₛₜ²/g² to a negligible level σₚₒₛₜ²/g²<<σₚᵣₑ². Therefore, a resulting dynamic range may be expressed as l_{wc}/σₚᵣₑ in Equation 11 below, for example.

$$\frac{{l}_{wc}}{{σ}_{pre}} ≫ \frac{{l}_{wc}}{{σ}_{post}} \qquad Equation 11$$

The spatially-varying gain may effectively reduce the read noise.

As described above, the imaging device of one or more embodiments may use the spatially-varying gain and spatially-varying binning to reduce noise and improve contrast in dark regions while maintaining resolution without saturating bright regions in an image.

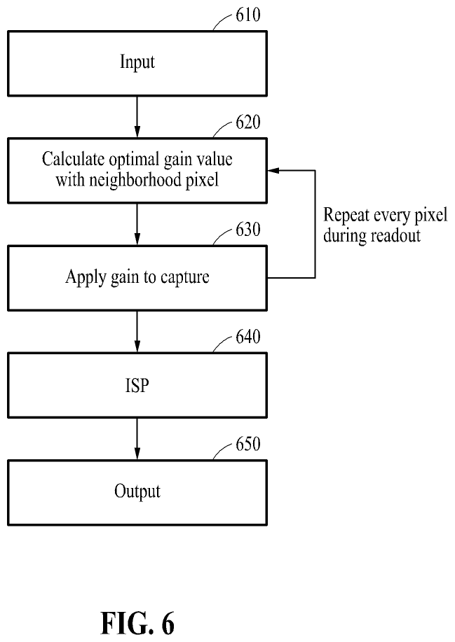

FIG. 6 illustrates a method of operating an imaging device according to one or more example embodiments. In embodiments described with reference to FIG. 6 and the following drawings, steps or operations may be performed in sequential order but may not necessarily be performed in sequential order. For example, the order of the steps or operations may be changed, and at least two of the steps or operations may be performed in parallel, or one step or operation may be divided to be performed accordingly. Referring to FIG. 6, diagram illustrates an example of determining a gain value for an image sensor using a pixel intensity of a neighboring pixel to improve image quality, according to one or more example embodiments.

The imaging device may apply a spatially-varying gain to each pixel. The imaging device may determine a gain value for each of a plurality of pixels using a pixel intensity of a neighboring pixel.

In operation 610, the imaging device may receive an input image captured by the image sensor. The input image may be a single shot image.

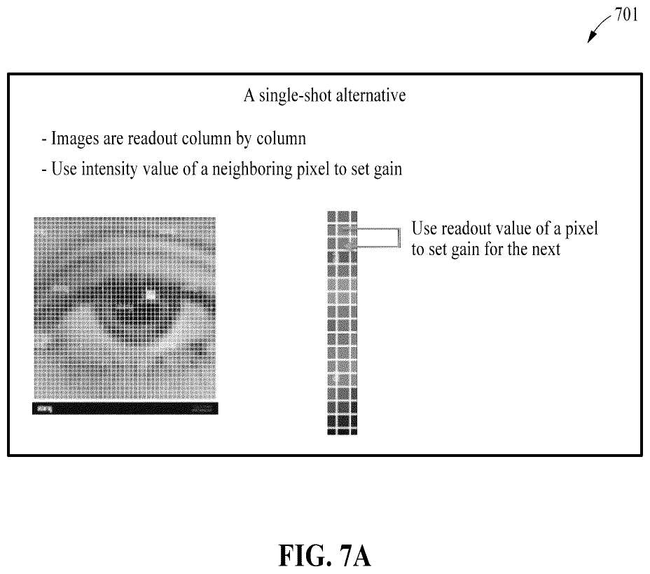

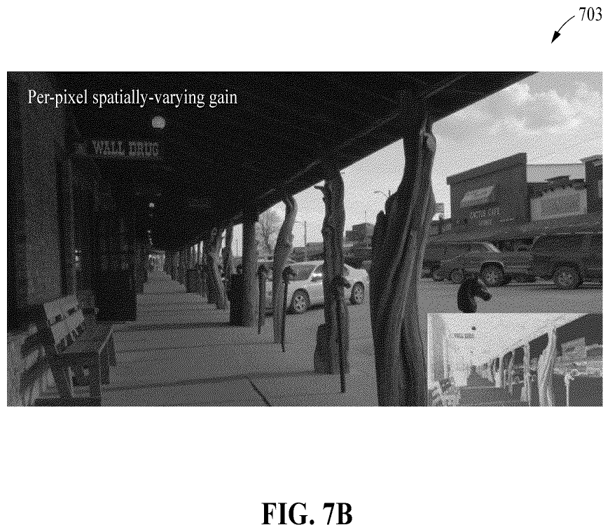

In operation 620, the imaging device may determine a gain value for each of a plurality of pixels using a pixel intensity of a neighboring pixel in the input image, as shown in FIG. 7A, for example.

In operation 630, the imaging device may apply pixel-wise the gain value determined in operation 620. The imaging device may iteratively perform operations 620 and 630 to apply a gain value to all the read pixels.

In operation 640, the imaging device may perform ISP on an image of the pixels to which the gain value is applied in operation 630.

In operation 650, the imaging device may output a resulting image obtained by performing the ISP in operation 640.

FIGS. 7A and 7B illustrate a result of determining a spatially-varying gain value for each divided region using a pixel intensity of a neighboring pixel in an imaging device according to one or more example embodiments.

Referring to FIG. 7A, diagram 701 illustrates an input image including a plurality of pixels. The imaging device may read each of the pixels of the input image, column-wise. For example, the imaging device may determine a gain value g for a pixel “b” that neighbors a pixel “a” by inputting a pixel intensity read from the pixel “a” into a max light level lₘₐₓ of Equation 10 above.

Referring to FIG. 7B, shown is a resulting image 703 obtained by applying a gain value determined for each of a plurality of pixels using a pixel intensity of a neighboring pixel. It may be verified from the resulting image 703 that noise in dark regions is reduced and contrast is improved, compared to a constant gain, while keeping bright regions unsaturated.

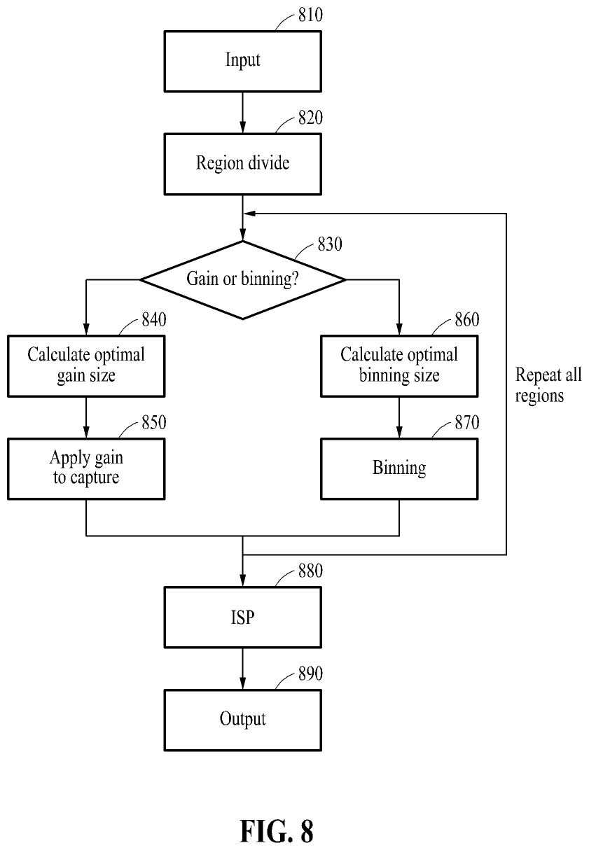

FIG. 8 illustrates a method of operating an imaging device according to one or more example embodiments. In embodiments described with reference to FIG. 8 and the following drawings, steps or operations may be performed in sequential order but may not necessarily be performed in sequential order. For example, the order of the steps or operations may be changed, and at least two of the steps or operations may be performed in parallel, or one step or operation may be divided to be performed accordingly. Referring to FIG. 8, a diagram illustrates an example of selecting and performing an operation suitable for improving image quality for each divided region of an input image, according to one or more example embodiments.

In operation 810, the imaging device may receive an input image captured by an image sensor.

In operation 820, the imaging device may divide the input image received in operation 810 into a plurality of regions.

In operation 830, the imaging device may determine whether to perform at least one of determining a binning size or determining a gain value, for each of the regions divided in operation 820. For each of the divided regions, the imaging device may select (or determine) an operation suitable for improving the image quality of a corresponding region from operations of changing the gain value and changing the binning size, and perform the operation suitable for each region separately.

In operation 840, when it is determined in operation 830 to perform the determination of the gain value, the imaging device may determine a corresponding gain value for each of the divided regions. In operation 850, the imaging device may capture an image obtained by applying the gain value determined in operation 840 to each of the regions divided in operation 820.

When it is determined in operation 830 that changing the gain value is advantageous for improving the image quality of a corresponding region, the imaging device may apply a spatially-varying gain value for each region in operations 840 and 850. In this example, bright regions of the image may remain the same without being saturated, and noise in dark regions may be reduced and contrast may be improved, compared to a constant gain.

Alternatively, in operation 860, when it is determined in operation 830 to perform the determination of the binning size, the imaging device may determine the binning size. In operation 870, the imaging device may perform binning on each of the regions divided in operation 820 based on the binning size determined in operation 860.

When it is determined in operation 830 that changing the binning size is advantageous for improving the image quality of a corresponding region, the imaging device may apply a spatially-varying binning size for each region in operations 860 and 870. It may be verified that applying the spatially-varying binning size for each region may reduce noise and improve contrast in dark regions, compared to a constant gain, while keeping brighter regions unsaturated overall. The imaging device may iteratively perform operations 830 to 870 on the previously divided regions.

In operation 880, the imaging device may perform ISP by combining the image captured in operation 850 and a result obtained by performing the binning in operation 870.

In operation 890, the imaging device may output a resulting image obtained by performing the ISP in operation 880.

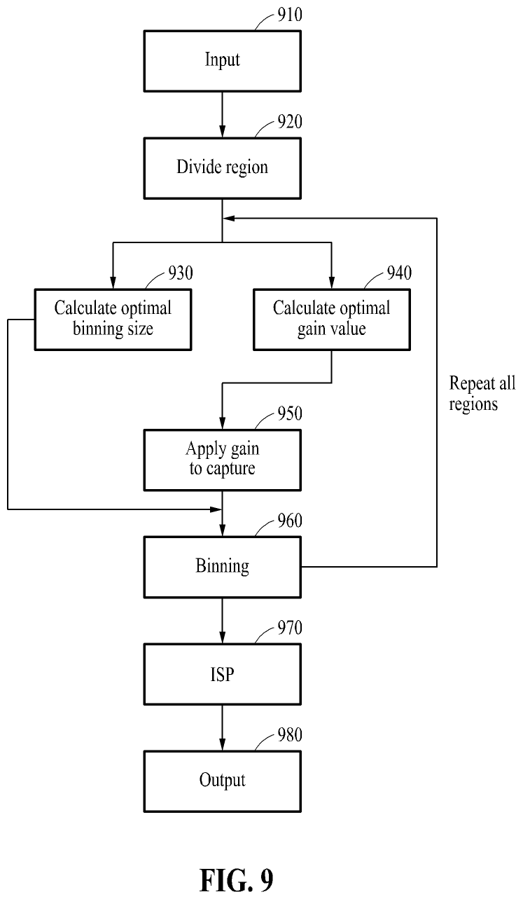

FIG. 9 illustrates a method of operating an imaging device according to one or more example embodiments. In embodiments described with reference to FIG. 9 and the following drawings, steps or operations may be performed in sequential order but may not necessarily be performed in sequential order. For example, the order of the steps or operations may be changed, and at least two of the steps or operations may be performed in parallel, or one step or operation may be divided to be performed accordingly. Referring to FIG. 9, diagram illustrates an example of processing, in parallel, determination of a binning size and determination of a gain value, by the imaging device, according to one or more example embodiments.

The imaging device may process, in parallel, the determination of a binning size and the determination of a gain value, which are performed sequentially according to one or more embodiments described above with reference to FIG. 3, and may thereby increase the speed of computation.

For example, in operation 910, the imaging device may receive an input image captured by an image sensor.

In operation 920, the imaging device may divide the input image received in operation 910 into a plurality of regions.

The imaging device may perform, in parallel, operation 930 of determining a binning size and operation 940 of determining a gain value, on each of the regions divided in operation 920.

In operation 950, the imaging device may capture an image in which the gain value determined in operation 940 is applied to each of the regions divided in operation 920.

In operation 960, the imaging device may perform binning by applying the binning size determined in operation 930 to the image captured in operation 950. The imaging device may iteratively perform operations 930 to 960 on all the previously divided regions.

In operation 970, the imaging device may perform ISP on a result of performing the binning in operation 960.

In operation 980, the imaging device may output a resulting image obtained by performing the ISP in operation 970.

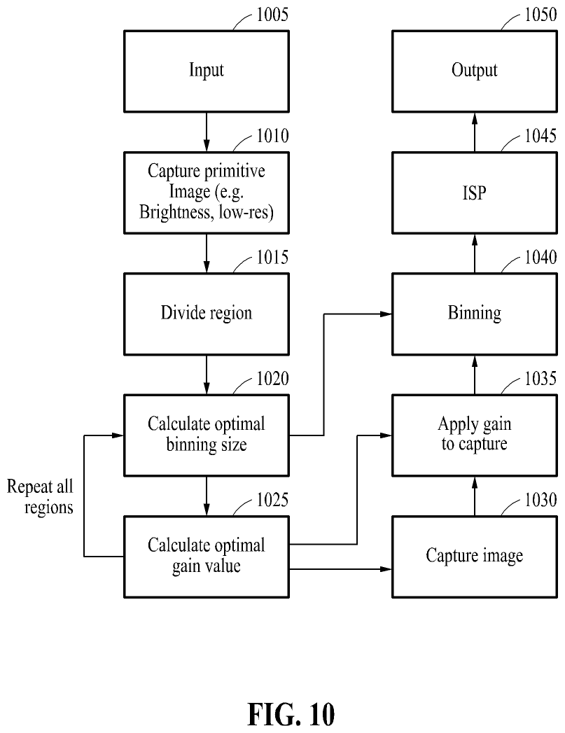

FIG. 10 illustrates a method of operating an imaging device according to one or more example embodiments. In embodiments described with reference to FIG. 10 and the following drawings, steps or operations may be performed in sequential order but may not necessarily be performed in sequential order. For example, the order of the steps or operations may be changed, and at least two of the steps or operations may be performed in parallel, or one step or operation may be divided to be performed accordingly. Referring to FIG. 10, a diagram illustrates an example of processing a high-resolution image by preprocessing a low-resolution image by the imaging device, according to one or more example embodiments.

The imaging device may capture a low-resolution light image, before capturing a high-resolution image, and perform a preprocessing process to obtain an optimal binning size and gain value for each region. The imaging device may then apply information (e.g., a binning size and gain value for each region) obtained during the preprocessing to the high-resolution image to improve the image quality of the high-resolution image.

In operation 1005, the imaging device may receive an input image that is input to an image sensor.

In operation 1010, the imaging device may capture the input image received in operation 1005. The captured input image may be, for example, but is not necessarily limited to, an unprocessed, low-resolution, primitive image or raw image.

In operation 1015, the imaging device may divide the primitive image captured in operation 1010 into a plurality of regions. After dividing the input image into the plurality of regions, the imaging device may sequentially obtain optimal binning sizes and gain values for the divided regions, respectively.

In operation 1020, the imaging device may determine a corresponding binning size for each of the regions divided in operation 1015, based on a light level of the primitive image captured in operation 1010.

In operation 1025, the imaging device may determine a corresponding gain value for each of the regions divided in operation 1015 based on the binning size determined in operation 1020. Increasing the gain value of the image sensor may improve an SNR but may result in saturated regions of an image. To solve this, according to one or more embodiments, a spatially-varying gain may be applied for each of the divided regions. The imaging device may iteratively perform operations 1020 and 1025 until the determination of the binning size and gain value is completed for all the divided regions.

In operation 1030, the imaging device may capture a high-resolution image corresponding to the low-resolution image (e.g., the low-resolution primitive image) captured in operation 1010 by the image sensor. The high-resolution image may be an image of the same scene as the low-resolution image.

In operation 1035, the imaging device may apply the gain value determined in operation 1025 to the high-resolution image captured in operation 1030.

In operation 1040, the imaging device may perform binning on the high-resolution image to which the gain value is applied in operation 1035, based on the binning size determined in operation 1020.

In operation 1045, the imaging device may perform ISP on a result of performing the binning in operation 1040.

In operation 1050, the imaging device may output a resulting image obtained by performing the ISP in operation 1045.

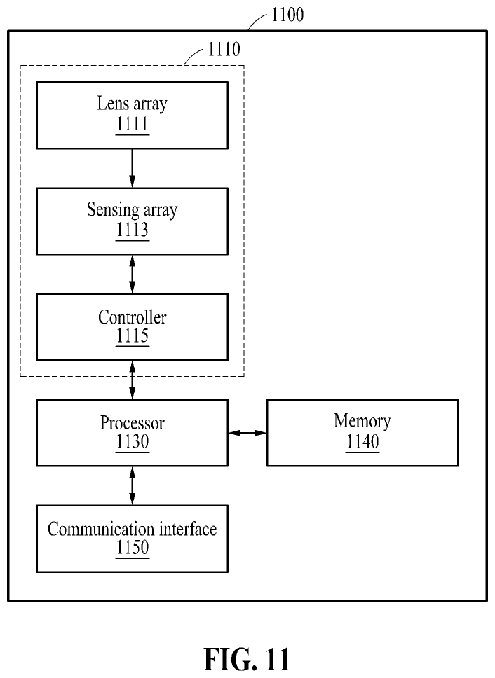

FIG. 11 illustrates an imaging device according to one or more example embodiments. Referring to FIG. 11, according to one or more embodiments, an imaging device 1100 may include an image sensor 1110, a processor 1130 (e.g., one or more memories), a memory 1140 (e.g., one or more memories), and a communication interface 1150.

The image sensor 1110 may capture an input image. The image sensor 1110 may include, for example, but is not necessarily limited to, a lens array 1111, a sensing array 1113, and a controller 1115 (e.g., one or more processors). The lens array 1111 may be included in the image sensor 1110 or may be configured separately from the image sensor 1110.

The image sensor 1110 may be a sensor configured to sense light that has passed through the lens array 1111. According to one or more embodiments, the image sensor 1110 may group sensing elements of the sensing array 1113 based on a binning size determined by a light level. A pixel value of a pixel may be determined based on a sum of intensity values sensed by the sensing elements grouped based on the binning size.

The lens array 1111 may include one or more imaging lenses, each corresponding to a single color. The lens array 1111 may include, for example, a first imaging lens corresponding to a first color (e.g., red), a second imaging lens corresponding to a second color (e.g., green), and a third imaging lens corresponding to a third color (e.g., blue). The imaging lenses of the lens array 1111 may respectively cover sensing areas of the sensing array 1113 corresponding to their lens sizes. The sensing areas in the sensing array 1113 covered by the imaging lenses may be determined by lens specifications (e.g., size, curvature, and thickness) of the corresponding imaging lenses. The sensing areas may be areas on the sensing array 1113 where light rays of a given field of view (FOV) reach after passing through the corresponding imaging lenses. The size of each of the sensing areas may be represented by a distance or diagonal length from the center of a corresponding sensing area to an outermost point of the sensing area. That is, on sensing elements included in each of the sensing areas, light that has passed through a corresponding imaging lens may be incident.

The lens array 1111 may include lens elements, such as, the imaging lenses described above, and the image sensor 1110 may include optical sensing elements. The lens elements may be disposed along a plane of the lens array 1111, and the optical sensing elements may be disposed along a plane of the sensing array 1113 in the image sensor 1110. The plane of the lens array 1111 may be disposed parallel to the plane of the sensing array 1113. The lens array 1111 may be a multi-lens array (MLA) for imaging, which may also be referred to as an imaging lens array.

An optical sensing element (hereinafter “sensing element”) described herein may be an element configured to sense optical information based on light incident on the element, and may output a value indicative of the intensity of the incident light. The optical sensing element may include, for example, a complementary metal-oxide-semiconductor (CMOS), a charge-coupled device (CCD), and a photodiode.

Each of the sensing elements of the sensing array 1113 may generate sensing information based on light that has passed through the imaging lenses of the lens array 1111. For example, a sensing element may sense, as the sensing information, an intensity value of light received through an imaging lens. Based on the sensing information output by the sensing array 1113, the imaging device 1100 and/or the image sensor 1110 may determine intensity information corresponding to an original signal for points included in an FOV of the imaging device 1100. The imaging device 1100 and/or the image sensor 1110 may restore the captured image based on the determined intensity information. For example, a sensing element may generate, as the sensing information, a color intensity value corresponding to a desired color by sensing light that has passed through a color pass filtering element. Each of the plurality of sensing elements included in the sensing array 1113 may be arranged to sense light of a specified color wavelength for each of the sensing areas. In the sensing array 1113, sensing elements disposed in a color sensing area corresponding to a single color among a plurality of colors may sense the intensity of light that has passed through a corresponding imaging lens and color filter of the single color.

The controller 1115 may group sensing elements disposed in each color sensing area based on a binning size determined based on a light level. For example, the controller 1115 may group first sensing elements, second sensing elements, and third sensing elements based on the binning size determined based on the light level. The controller 1115 may generate sensing data based on the sensing of the grouped first sensing elements, the grouped second sensing elements, and the grouped third sensing elements. The controller 1115 may generate the sensing data based on a light intensity sensed by the grouped sensing elements. The sensing data may include partial images of respective sensing areas and/or intensity information for the partial images.

The processor 1130 may divide an input image captured by the image sensor 1110 into a plurality of regions. The processor 1130 may determine a corresponding binning size for each of the divided regions based on a light level of the input image. The processor 1130 may determine a corresponding gain value for each of the divided regions based on the binning size. The processor 1130 may perform binning on an image captured by applying the gain value to each of the divided regions, respectively. The processor 1130 may perform ISP on a result of performing the binning.

The processor 1130 may restore the image based on the sensing information sensed by the sensing elements. The processor 1130 of the image sensor 1110 may also be referred to as an image signal processor. The sensing information may be used not only for image restoration, but also for object depth estimation, refocusing, dynamic range imaging, and high-sensitivity imaging in low-light environments.

The processor 1130 may be, for example, an application processor (AP).

The communication interface 1150 may output a resulting image obtained by performing the ISP by the processor 1130.

The processor 1130 may control the overall operation of the imaging device 1100. The processor 1130 may include a single processor core (single core) or a plurality of processor cores (multi-core). The processor 1130 processes or executes programs and/or data stored in the memory 1140. For example, the memory 1140 may include a non-transitory computer-readable storage medium storing instructions that, when executed by the processor 1130, configure the processor 1130 to perform any one, any combination, or all of the operations and/or methods described above with reference to FIGS. 1 through 10. The processor 1130 may control the functions of the image sensor 1110 by executing the programs stored in the memory 1140. The functions of the processor 1130 may be implemented as a central processing unit (CPU), a graphics processing unit (GPU), an application processor (AP), and/or the like.

The memory 1140 may be a storage configured to store data and may store an operating system (OS), various types of programs, and various types of data. The memory 1140 may include a volatile memory and/or a non-volatile memory. The non-volatile memory may include read-only memory (ROM), programmable ROM (PROM), erasable programmable ROM (EPROM), electrically erasable ROM (EEPROM), flash memory, phase-change RAM (PRAM), MRAM, resistive RAM (RRAM), ferroelectric RAM (FeRAM), and the like. The volatile memory may include DRAM, SRAM, synchronous DRAM (SDRAM), PRAM, MRAM, RRAM, FeRAM, and/or the like. The memory 1140 may include, for example, hard disk drives (HDDs), solid state drives (SSDs), compact flash (CF) memory, secure digital (SD) memory, micro-SD memory, mini-SD memory, extreme digital (xD) memory, and/or memory sticks.

The imaging device 1100 may obtain low-resolution input images for respective colors through various sensing information obtained as described above, and may restore a higher resolution output image from the low-resolution input images. The imaging device 1100 and/or the image sensor 1110 may adjust a binning factor (e.g., a binning size) for each of different light levels to obtain an image optimized for a corresponding light level.

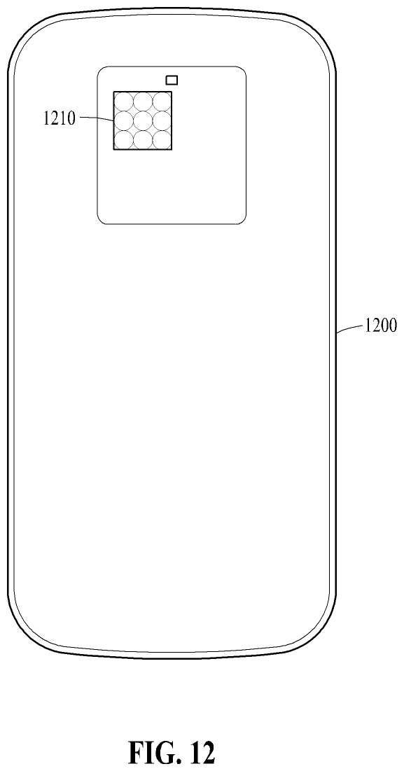

FIG. 12 illustrates an example electronic device in which an imaging device is implemented according to one or more example embodiments.

An image sensor and/or imaging device may be applied in various technical fields. Because a lens array including a plurality of lenses and a sensor including a plurality of sensing elements may be designed to be spaced apart by a relatively short focal length, the imaging device may be implemented as an ultra-thin camera with a large sensor size and small thickness, enabling high-quality imaging.

The image sensor and/or imaging device may be mounted on a mobile terminal 1200. The mobile terminal 1200 may be a movable device that is not fixed to a position, and may include, for example, a portable device such as a smartphone, a tablet, a foldable smartphone, and an artificial intelligence (AI) speaker, a vehicle, or the like.

As shown in FIG. 12, an imaging device 1210 may be applied to a front camera or a rear camera of the mobile terminal 1200 (e.g., a smartphone). The imaging device 1210 may be applied to a cell phone camera of a structure in which a large full-frame sensor and a multi-lens array are combined.

The imaging device 1210 may also be implemented as a thin or curved structure to be applied to a vehicle, or the imaging device 1210 may be implemented as a front camera or a rear camera with a curved structure to be applied to a vehicle. Further, the imaging device 1210 may be applied in applications, such as, for example, digital single-lens reflex (DSLR) cameras, drones, closed-circuit televisions (CCTVs), cameras for webcams, 360-degree cameras, cameras for movies and broadcasts, virtual reality (VR)/augmented reality (AR) cameras, flexible or stretchable cameras, compound-eye cameras, contact lens-type cameras, or the like. Further, the imaging device 1210 may be applied to multi-frame super-resolution image restoration that increases resolution using information from captured multiple frames.

The image sensors, photodiodes, A/D converters, imaging devices, processors, memories, communication interfaces, lens arrays, sensing arrays, controllers, mobile terminals, image sensor 100, photodiode 110, A/D converter 130, imaging device 1100, image sensor 1110, processor 1130, memory 1140, communication interface 1150, lens array 1111, sensing array 1113, controller 1115, mobile terminal 1200, and imaging device 1210 described herein, including descriptions with respect to respect to FIGS. 1-12, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-12 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
dividing an input image captured by an image sensor into a plurality of regions;
determining either one or both of a binning size and a gain value of the image sensor corresponding to each of the divided regions, based on a light level of the input image;
performing binning by applying the either one or both of the binning size and the gain value, for each of the divided regions; and
outputting a resulting image generated by performing image signal processing (ISP) on a result of the performing of the binning.

2. The method of claim 1, wherein the dividing into the plurality of regions comprises either one or both of:
dividing the input image into the plurality of regions corresponding to a plurality of pixels; and
dividing the input image into the plurality of regions corresponding to a plurality of regions of interest (ROIs).

3. The method of claim 2, wherein the determining of the either one or both of the binning size and the gain value comprises:
determining a corresponding binning size for each of the divided regions based on the light level of the input image; and
determining a corresponding gain value for each of the divided regions based on the binning size.

4. The method of claim 3, wherein the determining of the binning size comprises determining the binning size based on a resolution corresponding to the light level.

5. The method of claim 4, wherein the determining of the binning size comprises:
determining a size of effective pixels among the plurality of pixels based on a light level-based pixel size-specific modulation transfer function (MTF), which is an MTF for each size of the plurality of pixels according to the light level, and on noise corresponding to the image sensor; and
determining the binning size based on the size of the effective pixels.

6. The method of claim 5, wherein the determining of the size of the effective pixels comprises determining the size of the effective pixels by a first intersecting point between the light level-based pixel size-specific MTF and the noise.

7. The method of claim 3, wherein the determining of the gain value comprises determining the gain value for each of the plurality of pixels using a pixel intensity of a neighboring pixel adjacent to a target pixel among the plurality of pixels.

8. The method of claim 7, wherein the determining of the gain value for each of the plurality of pixels comprises:
determining a first maximum (max) light level for each of the plurality of pixels; and
applying the first max light level to a saturation voltage value of the image sensor to determine the gain value for each of the plurality of pixels.

9. The method of claim 3, wherein the determining of the binning size comprises determining the binning size based on a resolution corresponding to a light level of each of the plurality of ROIs.

10. The method of claim 3, wherein the determining of the gain value comprises determining the gain value for each of the plurality of ROIs.

11. The method of claim 10, wherein the determining of the gain value for each of the plurality of ROIs comprises:
determining a second max light level for each of the plurality of ROIs; and
applying the second max light level to a saturation voltage value of the image sensor to determine the gain value for each of the plurality of ROIs.

12. The method of claim 1, wherein the performing of the binning comprises performing the binning iteratively on each of the divided regions to allow the binning to be performed on an entirety of the input image.

13. The method of claim 1, wherein the performing of the binning comprises performing the binning by one or more binning modes among additive binning, average binning, and ISP post-processing binning.

14. The method of claim 2, wherein the determining of the either one or both of the binning size and the gain value comprises determining the gain value for each of the plurality of pixels, using a pixel intensity of a neighboring pixel.

15. The method of claim 1, further comprising:
determining whether to perform either one or both of a determination of the binning size and a determination of the gain value, for each of the divided regions,
wherein, in response to the determination of the gain value being determined to be performed, the determining of the gain value comprises:
determining a corresponding gain value for each of the divided regions; and
capturing an image in which the gain value is applied to each of the divided regions, respectively.

16. The method of claim 15, wherein, in response to the determination of the binning size being determined to be performed, the performing of the binning further comprises:
determining the binning size; and
performing the binning on each of the divided regions based on the determined binning size.

17. The method of claim 1, wherein the determining of the binning size and the determining of the gain value are performed in parallel.

18. A processor-implemented method comprising:
dividing an input image captured by an image sensor into a plurality of regions;
determining a corresponding binning size for each of the divided regions based on a light level of the input image;
determining a corresponding gain value for each of the divided regions based on the binning size;
performing binning on an image captured by applying the gain value to each of the divided regions, respectively; and
outputting a resulting image generated by performing image signal processing (ISP) on a result of the performing of the binning.

19. A processor-implemented method comprising:
dividing a low-resolution image captured by an image sensor into a plurality of regions;
determining a corresponding binning size for each of the divided regions based on a light level;
determining a corresponding gain value for each of the divided regions based on the binning size;
capturing, by the image sensor, a high-resolution image corresponding to the low-resolution image;
applying the gain value to the high-resolution image;
performing binning on the high-resolution image to which the gain value is applied, based on the binning size; and
outputting a resulting image generated by performing image signal processing (ISP) on a result of the performing of the binning.

20. An imaging device comprising:
one or more processors configured to:
divide an input image captured by an image sensor into a plurality of regions;
determine a corresponding binning size for each of the divided regions based on a light level of the input image;
determine a corresponding gain value for each of the divided regions based on the binning size;
perform binning on an image captured by applying the gain value to each of the divided regions, respectively; and
perform image signal processing (ISP) on a result of performing the binning; and
a communication interface configured to output a resulting image generated by the performing of the ISP.
